(19) United States
(12) Patent Application Publication
(10) Pub. No.: US 2003/0084037 A1
(43) Pub. Date: May 1, 2003

(54) Search server and contents providing system

(75) Inventor: Yoshihisa Kizuka, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/283,235

(22) Filed: Oct. 30, 2002

(30) Foreign Application Priority Data
Oct. 31, 2001 (JP) 2001-335535

(51) Int. Cl. G06F 7/00

(52) U.S. Cl. 707/3

(57) ABSTRACT

A search server includes readout unit for searching a search database, which stores guide information and viewing results for contents items each of which is composed of video and audio, in response to a search request in which search conditions including at least a keyword transmitted are specified from a viewer terminal over a network to thereby read out guide information for at least one contents item that satisfies the search conditions, and transmitter for transmitting to the requesting viewer terminal the read guide information for the at least one contents item and display order priority based on the viewing results for the contents item.

### CROSS-REFERENCE TO RELATED APPLICATIONS

This application is based upon and claims the benefit of priority from the prior Japanese Patent Application No. 2001-335535, filed on Oct. 31, 2001, the entire contents of which are incorporated herein by reference.

### BACKGROUND OF THE INVENTION

1. Field of the Invention

The present invention relates to a search server which provides contents made up of video and audio for many viewers over a network, such as the Internet, and a content providing system which has the search server built in and provides the contents for many viewers.

2. Description of the Related Art

In recent years, the transmission rate of communication lines between terminals installed in viewers' homes and Web servers that provide various information for the viewers with or without charge has been increased. This has allowed the high-speed transmission and reception of large-capacity contents which allow moving images composed of video and audio and compatible even with large screens to be displayed in real time.

Therefore, each viewer can make access through the terminal installed in his or her home to each Web server on the Internet to obtain pay or free contents, such as movies, news, etc., from it.

Conventionally, in retrieving video and audio contents, such as streaming contents, over the Internet, each viewer uses his or her terminal to carry out the following procedure:

(a) The user enters the title of a contents item on the search system of the information provider's Web site on the Internet to retrieve that contents item. Using the same search system, the viewer traces genres (categories) in sequence and finally reaches his or her target contents item.

(b) The viewer searches for the contents producing company's Web site on the Internet and then traces its links to reach the target contents item.

However, the conventional approach to obtain the target contents item using the search system of the information providing company's Web site or the contents producing company's Web site has the following problems to be resolved.

That is, the information providing company's Web site has an enormous number of contents items which are registered categorized in a tree-like form and include not only contents of moving images comprised of video and audio but also contents items of text only, contents items of still images only, and contents items of combined text and still images. As a consequence, the viewer will have to search through many genres for a target moving-image contents item. This is very troublesome for viewers.

In the contents producing company's Web site, on the other hand, in principle only the contents produced by that company are registered. It is therefore possible for the viewer to arrive at the target contents relatively easily. If the producing company of the target contents is unknown, however, it is impossible for the viewer to arrive at the target contents.

To eliminate such inconvenience, a Web site has been put into practice which is adapted to allow the search of each contents item using a keyword composed of a straightforward character string. The keyword-based search allows the number of search operations to be reduced.

In general, in view of operability there is a limit to the number of characters in a keyword that can be entered. Thus, contents that match the keyword may amount to some tens of items. In such a case, these contents items are generally displayed in the order of registration beginning with the oldest or in the order of viewing beginning with the latest. Furthermore, they may also be displayed in descending order of the number of other contents (sites) to which each contents item is linked.

In any case, the viewer needs to search for a target contents item by scrolling through the titles of several tens of contents items displayed on the corresponding terminal.

Thus, the keyword-based search system has a problem of failure to retrieve a target contents item in an efficient manner.

### BRIEF SUMMARY OF THE INVENTION

It is therefore an object of the present invention to provide a search server and a contents providing system which, where two or more contents items appear in the result of keyword-based search, permit their titles to be displayed on a viewer terminal based on their viewing results to thereby allow each viewer to retrieve his or her target contents item in a short time and in an effective manner, and allow contents providers to improve significantly service to viewers.

To attain the object, a search server according to a first aspect of the present invention comprising: readout means for searching a search database, which stores guide information and viewing results for contents items each of which is composed of video and audio, in response to a search request in which search conditions including at least a keyword transmitted are specified, from a viewer terminal over a network to thereby read guide information for at least one contents item that satisfies the search conditions; and transmission means for transmitting to the requesting viewer terminal the read guide information for the at least one contents item and display order priority based on the viewing results for the contents item.

A method of search according to a second aspect of the present invention comprising: searching a search database, which stores guide information and viewing results for contents items each of which is composed of video and audio, in response to a search request in which search conditions including at least a keyword are specified transmitted from a viewer terminal over a network to thereby read guide information for at least one contents item that satisfies the search conditions; and transmitting to the requesting viewer terminal the read guide information for the at least one contents item and the display order priority based on the viewing results for the contents item.

A computer program product of search according to a third aspect of the present invention comprising: searching a search database, which stores guide information and viewing results for contents items each of which is composed of video and audio, in response to a search request in which search conditions including at least a keyword are specified transmitted from a viewer terminal over a network to thereby read out guide information for at least one contents item that satisfies the search conditions; and transmitting to the requesting viewer terminal the read guide information for the at least one contents item and display order priority based on the viewing result for the contents item.

In the search server, the search method and the search program thus configured, the search database is stored with guide information and viewing results for each of the contents items made up of moving video images and audio. If, as a result of searching the search database under search conditions including a keyword, there are two or more hits, then guide information for these contents items is displayed on the terminal of the requesting viewer in the order of display based on their viewing results.

Therefore, the viewer is allowed to know popular contents items easily, providing a criterion for making a selection from the contents items.

A fourth aspect of the present invention is a contents providing system which, in response to a request for transmission of a contents item from a viewer terminal over a network, reads out the contents item specified by the transmission request from a plurality of stored contents items each of which is made up of video and audio and then transmits the read contents item to the requesting viewer terminal over the network.

The system comprises: a search database which stores guide information and viewing results for each of the stored contents items; and a search server which is responsive to a search request in which search conditions including at least a keyword are specified from a viewer terminal over the network to search the search database, then read out guide information for at least one contents item that satisfies the search conditions and transmit to the requesting viewer terminal the read guide information together with display order priority based on the viewing results for each contents item.

The contents providing system thus configured allows a viewer to select easily his or her target contents item using the search server. When the viewer sends over the network a request for transmission of the target contents item, the specified contents item is selected from among contents items stored and then transmitted to his or her viewer terminal.

A fifth aspect of the present invention is a contents providing method which, in response to a request for transmission of a contents item from a viewer terminal over a network, reads out the contents item specified by the transmission request from a plurality of stored contents items each of which is made up of video and audio and then transmits the read contents item to the requesting viewer terminal over the network. The method comprises: each time a contents item is transmitted to a requesting viewer terminal, updating viewing results for the contents item in a search database which stores guide information and viewing results for the stored contents items by collecting information which identifies the contents item and viewer information; and, in response to a search request in which search conditions including at least a keyword are specified from a viewer terminal over the network, searching the search database, then reading guide information for at least one contents item that satisfies the search conditions and transmitting to the requesting viewer terminal the read guide information together with the display order priority based on the viewing results for each contents item.

According to the contents providing method thus configured, the viewing results for each contents item in the search database is automatically updated. Therefore, each viewer is allowed to select a contents items based on the latest viewing results.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic illustration of a contents providing system to which a search server, a search method, a search program and a contents providing method according to an embodiment of the invention are applied;

FIG. 2A shows the contents of the search database incorporated in the contents providing system shown in FIG. 1;

FIG. 2B shows exemplary contents of a record in the search database in FIG. 2A;

FIG. 3 shows the detailed contents of the viewing result field in the search database in FIG. 2A;

FIG. 4 shows the contents of the viewer information database in the contents providing system of FIG. 1;

FIG. 5 is a flowchart illustrating the operation of the search servers incorporated in the contents providing system of FIG. 1;

FIG. 6 shows the search information entry form displayed on the viewer's terminal incorporated in the contents providing system of FIG. 1;

FIG. 7 shows the search results displayed on the viewer's terminal incorporated in the contents providing system of FIG. 1;

FIG. 8 shows the search results and guide information displayed on the viewer's terminal incorporated in the contents providing system of FIG. 1;

FIG. 9 shows the search results displayed on the viewer's terminal incorporated in the contents providing system of FIG. 1;

FIG. 10 is a flowchart illustrating the operation of the distribution servers incorporated in the contents providing system of FIG. 1;

FIG. 11 is a flowchart illustrating the operation of the viewing result collection server incorporated in the contents providing system of FIG. 1; and

FIG. 12 is a schematic illustration of a contents providing system in which a search server according to another embodiment of the invention is incorporated.

### DETAILED DESCRIPTION OF THE INVENTION

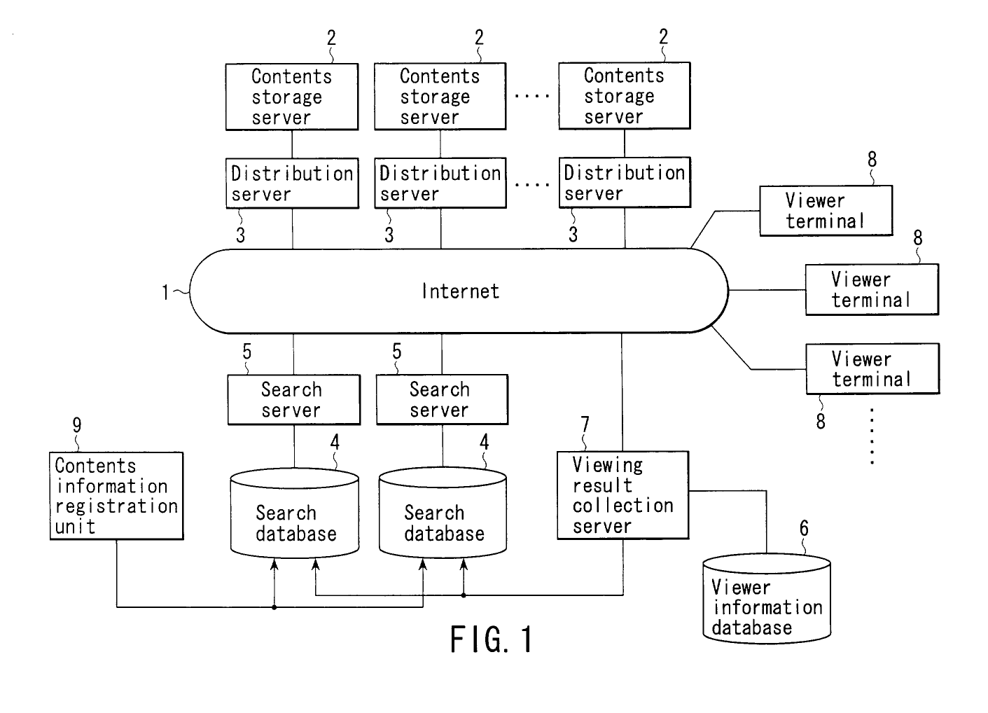

Referring now to FIG. 1, there is schematically illustrated a contents providing system to which a search server, a search method, a search program and a contents providing method embodying the present invention are applied.

To the Internet 1 as a network are connected a plurality of distribution servers 3 each of which has a contents storage server 2 connected thereto, a plurality of search servers 5 each of which has a search database connected thereto, a viewing result collection server 7 having a viewer information database 6 connected thereto, and a plurality of viewers' terminals 8. Furthermore, a contents information registration unit 9 is incorporated in the contents providing system.

The configuration of each component comprising the contents providing system will be described below in sequence.

Each of the contents storage servers 2 is stored with a large number of contents items, such as dramas, movies, news, animations, and so on, which are made up of video (moving images) and audio and can be provided for viewers. Each contents item is stored with a contents number appended. Each contents storage server 2 is not stored with contents which consist of text only, still images only, or merged text and still images.

Further, each contents storage server 2 is not stored with the same contents (i.e., each contents item is stored in a single storage server). This is intended to alleviate the burden on each distribution server 3 to distribute contents to each viewer's terminal 8.

Each distribution server 3 is comprised of a computer and, upon receiving from a viewer's terminal 8 a contents transmission request in which the viewer ID, the contents number and the distribution method of either “download distribution” or “streaming distribution” are specified, reads the contents item corresponding to the specified contents number from its associated contents storage server 2. The read contents item is then transmitted to the requesting terminal over the Internet 1 in accordance with the FTP (file transfer protocol), HTTP (hypertext transfer protocol), RTP (real-time transfer protocol) or the like.

The streaming distribution is a method of distribution which allows a viewer to view a contents item on his or her terminal while receiving it from a distribution server. The download distribution is a method of distribution which allows a viewer to reproduce and view a contents item which has previously been received from a distribution server and then stored in a storage device, such as an HDD, in his or her terminal.

Each search database 4 is stored with the content number, location information, program information, video/audio information, writer/producer information, and viewing result for each of the contents items stored in all the contents storage servers 2. The program information and the writer/producer information form guide information for each contents item.

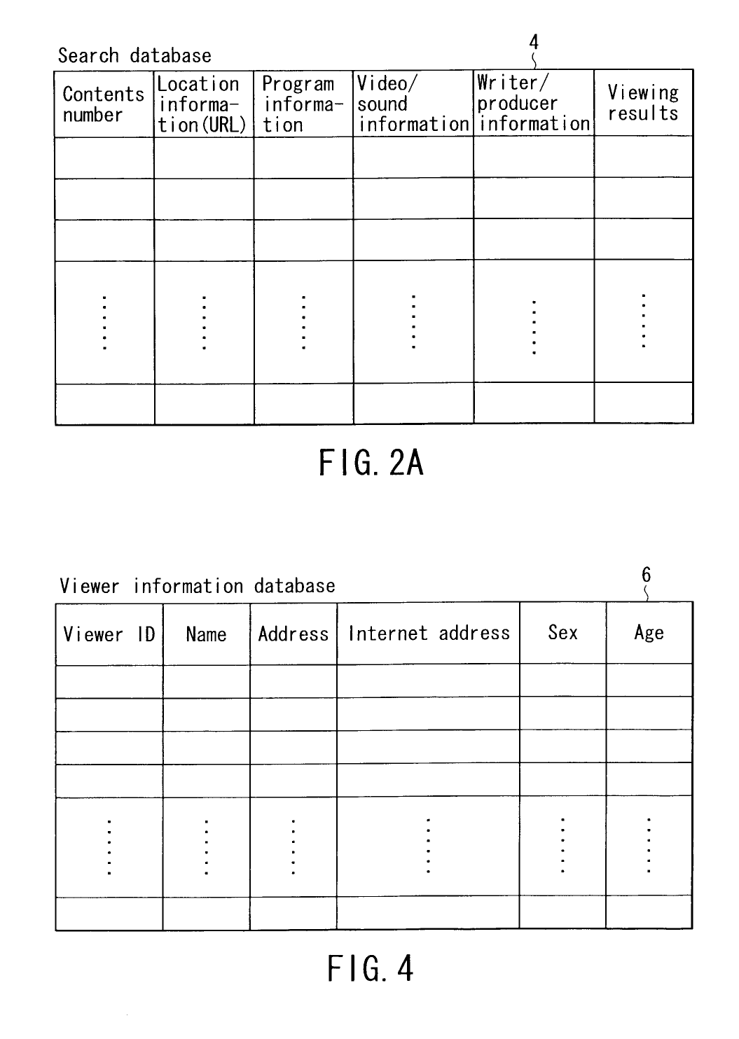

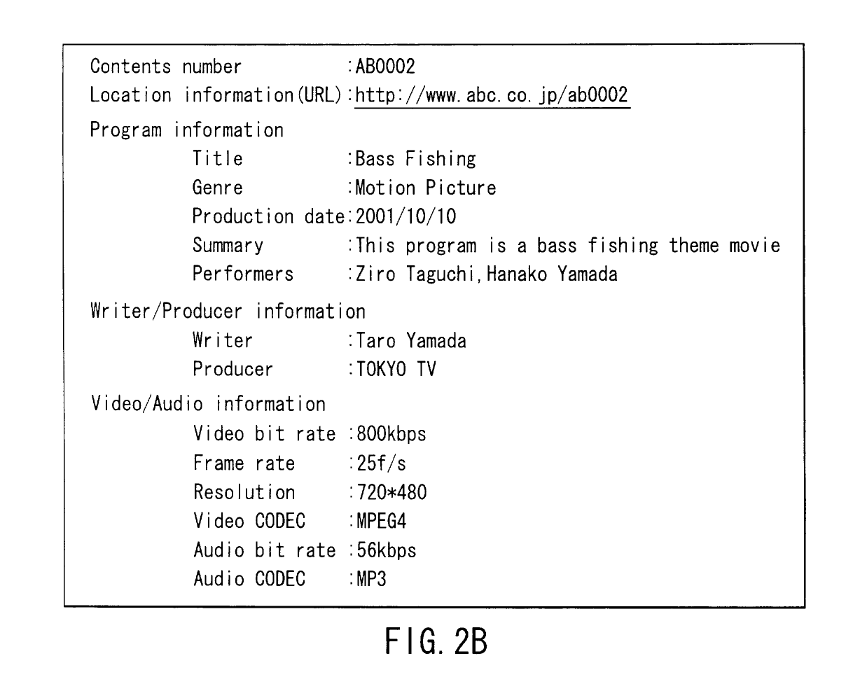

FIG. 2B shows a specific example of a record stored in the search database, which comprises the location information, the video/audio information, the writer/producer information, and the viewing result information. This example indicates that the title of the contents item is “bass fishing” and the genre is “motion picture”.

The location information is a URL that contains the address of a distribution server for accessing the corresponding contents item. The program information contains the title, the genre, the date of production, the summary, and the performers. The writer/producer information contains the writer and the producer.

As the video/audio information, the video bit rate, the frame rate, the resolution, the video CODEC, the audio bit rate and the audio CODEC are set up.

As the viewing result, the number of download distributions and the number of streaming distributions are set up. In addition, the number of times of viewing in each of time slots such as of morning, day, night, and midnight, and the numbers of times of viewing by viewer groups, such as teen-aged boys, women in their twenties, and men in their thirties, are set up.

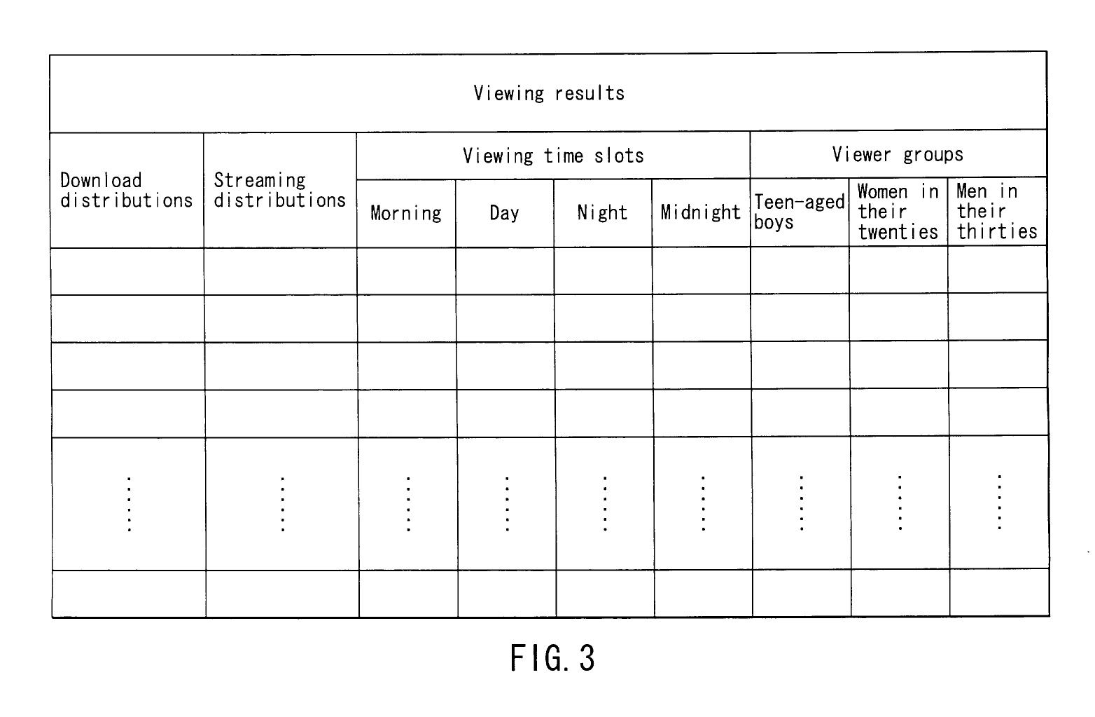

Each of the search databases 4 is written with the same data shown in FIGS. 2A, 2B and 3.

If the contents provider enters a contents item with a contents number into one of the contents storage server 2, the location information, the program information, the video/audio information and the writer/producer information but the viewing result information for that contents item are written by an administrator of the contents providing system into each of the search databases 4 at the same time.

The viewing result for each contents item is written by the viewing result collection server 7 into each of the search databases 4 at the same time.

Thus, the search databases 4 have always the same stored value.

Each search server 5 is comprised of a computer and, upon receipt of a search request from a viewer's terminal 8 that includes search conditions containing a keyword, looks up the titles of contents items that satisfy the search conditions in the corresponding search database 4 in accordance with a search program stored in it and then transmits the results to the requesting terminal.

The viewer information database 6 is stored, as shown in FIG. 4, with the viewer ID, the name, the address, the Internet mail address, sex, and age of each viewer at a respective one of the viewer terminals 8.

The viewing result collection server 7 is comprised of a computer and, each time a contents item is transmitted from a distribution server 3 to a requesting terminal 8, collects the contents number that identifies that contents item and the viewer ID as viewer information from that distribution server and updates the viewing results for that contents item in the search databases 4.

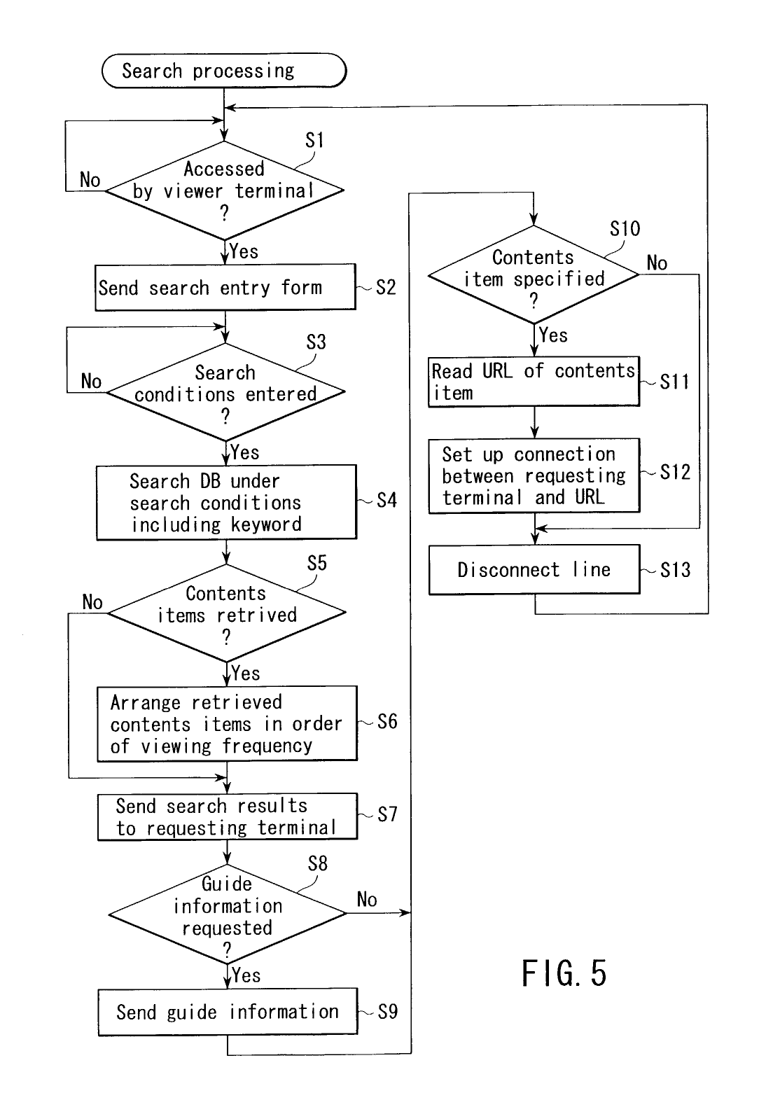

The operation of the search servers 5 based on the search program will be described below with reference to a flowchart of FIG. 5.

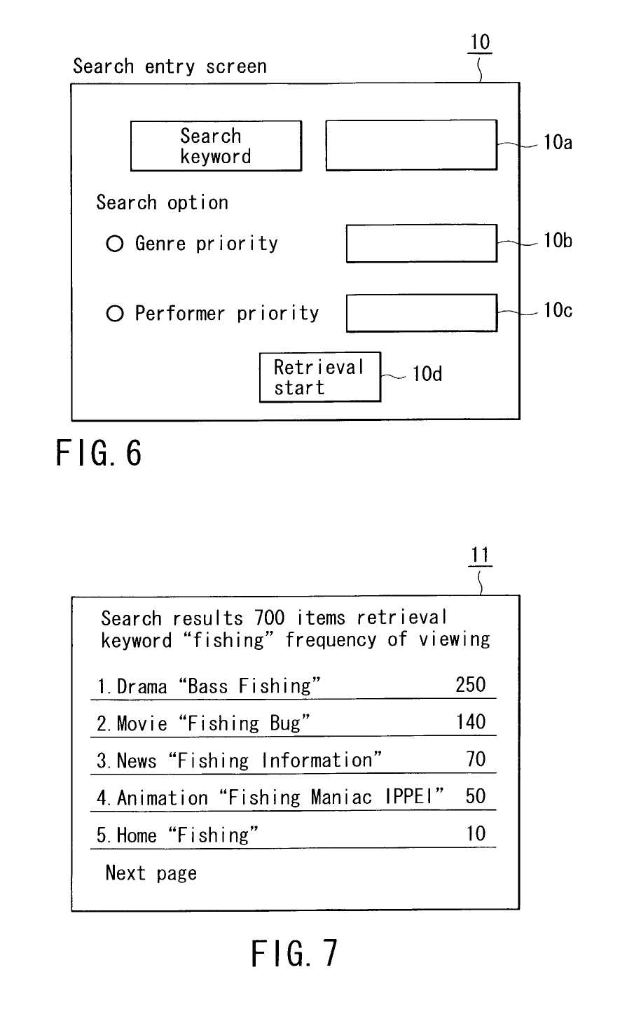

Upon receipt of an access request from a viewer terminal 8 over the Internet 1 (step S1), the search server 5 transmits as a search information entry form 10 as a home page shown in FIG. 6 to the requesting viewer terminal 8 (step S2). The search information entry form 10 has a keyword box 10a into which a keyword for search is entered, a genre box 10b into which a genre is to be entered, a performer box 10b into which a performer is to be entered, and a search start button 10d. The genre box 10b and the performer box 10b are used as the optional feature of setting up search conditions.

The viewer enters a keyword relevant to his or her desired contents item into the keyword box 10a. Note that two or more keywords may be entered. In this case, a specific delimiter implements AND and OR functions on the results of search. The viewer is allowed to specify either “genre priority” or “performer priority” as the option of making the search conditions more rigid.

When the viewer presses the start button 10d after filling in the search entry form (step S3), the search server searches the search database 4 under the search conditions including the keyword (step S4).

For example, when the viewer enters “fishing” as a search keyword into the keyword box 10a and selects “genre priority” as a search option to enter “movie” into the genre box 10b, the results of search (i.e., the titles of contents items of movies) can be obtained which match the keyword “fishing”.

Besides the example of FIG. 6, the search options can be provided in various forms within the range of contents information stored in the search database 4. For example, the utilization of the viewing results shown in FIG. 3 allows the following search options to be implemented:

Search of a contents item that was viewed most frequently on a specified day.

Search of a contents item that was downloaded most frequently during the most recent week.

Search of contents items that teen-aged boys and girls frequently watch.

Search of contents items that men frequently watch at midnight.

Search of contents items that women in their twenties frequently watch.

When two or more contents items are retrieved (step S5), they are rearranged in the decreasing order of the frequency of viewing obtained from the viewing results shown in FIG. 3 (step S6) and then transmitted to the requesting viewer terminal 8 as the results of search indicated at 11 in FIG. 7 (step S7).

FIG. 7 shows the results of search for the keyword of “fishing”. “Bass fishing” which is the title of the most frequently viewed drama so far is presented as the highest in the frequency of viewing.

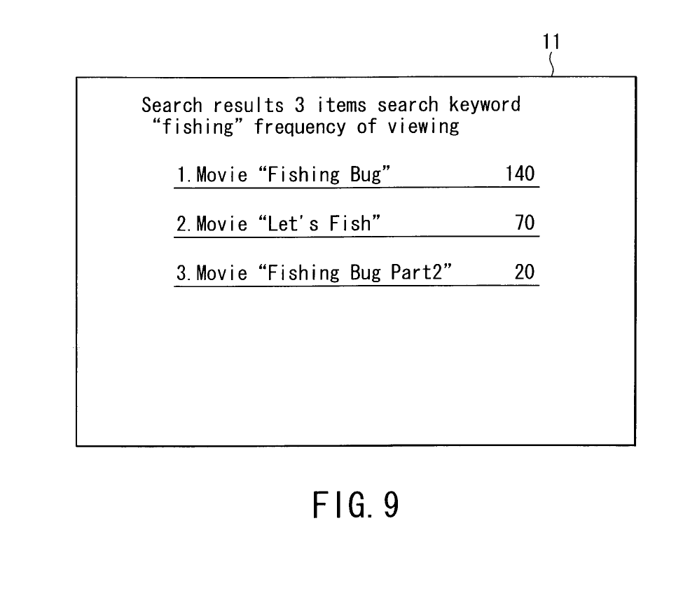

FIG. 9 shows the results of search under search conditions that the keyword is “fishing” and the genre as the optional feature is specified to be “movie”. As can be seen from FIG. 9, the titles of movies that contain characters of “fishing” are displayed in decreasing order of the frequency of viewing.

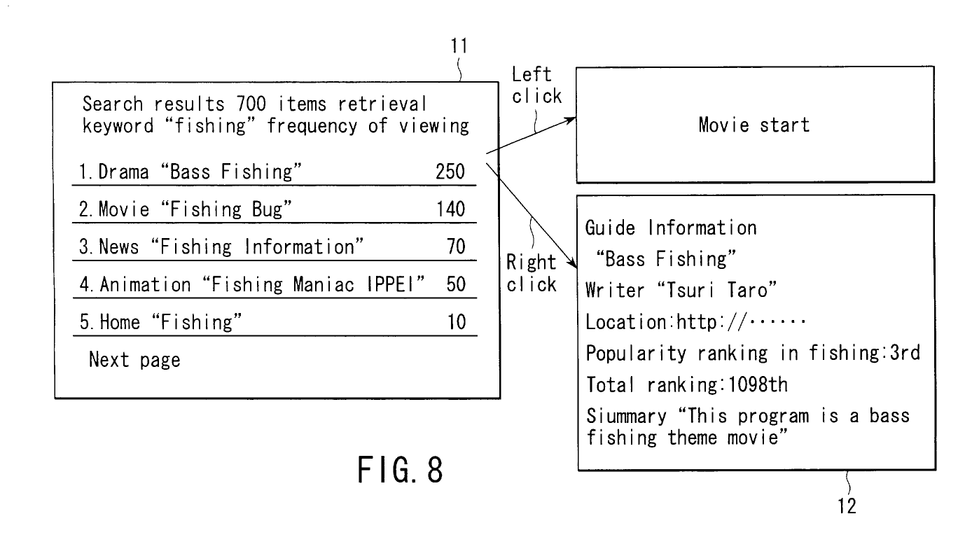

The results of search are displayed on the screen of the requesting viewer terminal 8. When the viewer right clicks the title of a contents item of interest with a mouse as shown in FIG. 8, a request for transmission of guide information for that contents item is sent to the search server 5 (step S8).

Upon receipt of that request, the search server 5 edits guide information (detailed information) 12 from the location information, the writer, the order of popularity in the corresponding category calculated from the viewing result and a brief summary for that contents item and then sends it to the requesting viewer terminal 8 (step S9). In the requesting viewer terminal 8, the received guide information 12 is displayed in such a form as shown in FIG. 8.

When, as shown in FIG. 8, the viewer specifies (left clicks) the title of the contents item he or she wants to watch (step S10), the search server 5 reads an URL indicating the location of that contents item from the search database 4 (step S11). The search server 5 connects the requesting viewer terminal 8 to the URL indicating the location of that contents item (step S13) and then disconnects the communication link with the requesting terminal 8 (step S13).

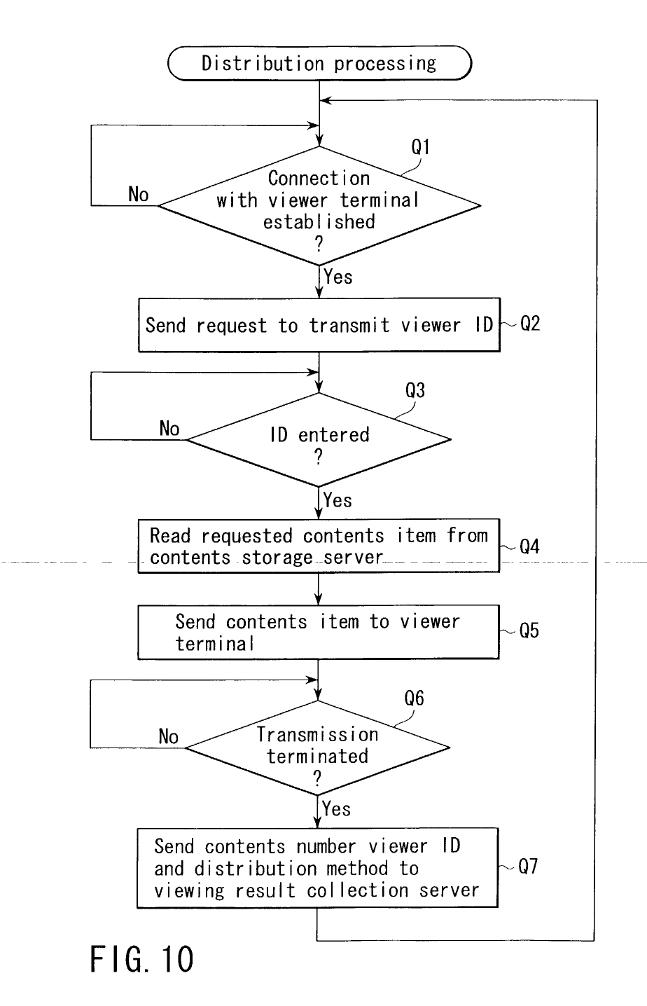

Next, the operation of the distribution servers 3 that send contents to the viewer terminals 8 will be described with reference to a flowchart of FIG. 10.

When the connection with a requesting viewer terminal 8 is established over the Internet 1 by link processing of the search server 5 (step Q1), the distribution server 3 sends to the requesting viewer terminal 8 a request to transmit the viewer ID (step Q2). Upon receipt of the viewer ID (Q3), the distribution server 3 starts reading from the corresponding contents storage server 2 a contents item corresponding to the contents number the location of which is specified by the URL (step Q4). The distribution server 3 then starts the transmission of the contents item to the requesting viewer terminal 8 according to a viewer-specified distribution method of either download distribution or streaming distribution (step Q5).

Upon termination of the transmission of the contents item to the requesting viewer terminal 8 according to the download distribution or streaming distribution (step Q6), the distribution server 3 sends the contents number, the viewer ID, the distribution method (download distribution or streaming distribution), and the time of distribution to the viewing result collection server 7 over the Internet 1 (step Q7).

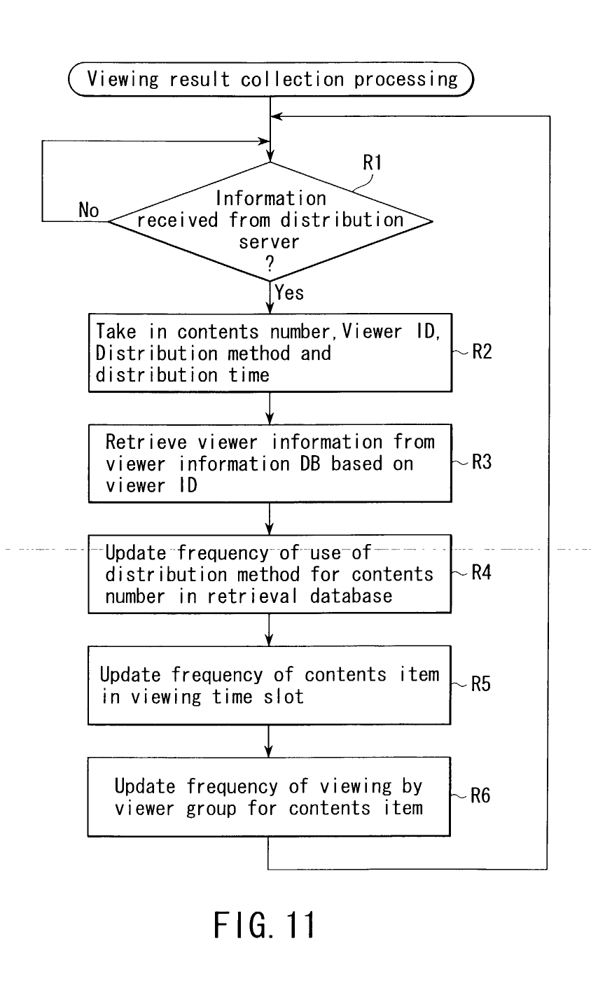

Next, the operation of the viewing result collection server 7 that updates the viewing results in the search databases 4 shown in FIG. 3 will be described with reference to a flowchart of FIG. 11.

Upon receipt of information from one distribution server 3 over the Internet 1 (step R1), the viewing result collection server 7 takes the contents number, the viewer ID, the distribution method, and the time of distribution contained in the information into its memory (step R2). The server 7 then searches the viewer information database 6 shown in FIG. 4 based on the viewer ID to obtain viewer information of sex, age, and so on (step R3).

The viewing result collection server 7 then updates the number of either download distributions or streaming distributions of the received contents number in the viewing results (FIG. 3) in the search database 4 (step R4). The server 7 further updates the number of times of viewing in one of the time slots of morning, day, night and midnight which corresponds to the time of distribution of the received contents number (step R5).

The server 7 further updates the number of times of viewing by either teen-aged boys, women in their twenties, or men in their thirties according to the sex and age of that viewer (step R6).

In the contents providing system thus configured, the search databases 4 connected to the search servers 5 accessible over the Internet 1 by viewers through their respective terminals 8 are stored, for each moving-image contents item, with the location information (URL), the guide information containing the title, the program information, the writer/producer information, the viewing results (the number of times of viewing by distribution methods, by time slots, and by viewer groups) as shown in FIGS. 2A, 2B and 3.

Each viewer uses the search information entry form 10 appearing on his or her terminal 8 to enter search conditions containing a keyword of a contents item of interest and its genre, such as drama, movie, news, animation or the like. Then, the search server 5 search their associated search database 4. When there are two or more hits for the search conditions as a search result 11, the titles of contents items are displayed in decreasing order of the number of times of viewing as shown in FIGS. 7 and 9. The viewer is therefore allowed to know popular contents items easily, providing a criterion for selecting contents.

The search databases 4 are stored, besides program information for contents items, with information as to what sorts of viewers frequently watch each contents item. Each viewer is therefore allowed to confirm program information for one or more contents items he or she retrieved and their popularity ranking on his or her viewer terminal 8. After confirmation, each viewer simply makes a request to send a desired contents item on the search result 11 display screen.

The viewing results for each content item stored in each of the search databases 4 is automatically updated by the viewing result collection server 7. Thus, the maintenance and management burden on the administrator of the contents providing system can be reduced significantly.

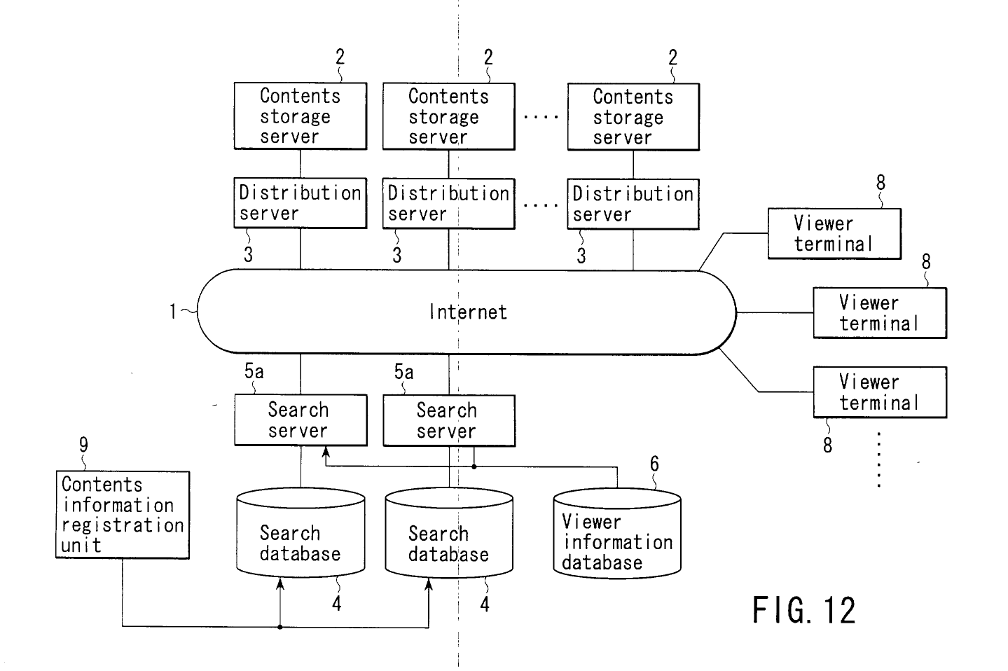

FIG. 12 is a schematic illustration of a contents providing system in which a search server according to another embodiment of the present invention is incorporated. In this figure, like reference numerals are used to denote corresponding parts to those in FIG. 1 and detailed descriptions thereof are omitted.

In this contents providing system, no viewing result collection server is incorporated.

After transmission of a contents item to a viewer terminal 8, a distribution server 3 sends the contents number, the viewer ID, the distribution method of either download distribution or streaming distribution, and the time of distribution to search servers 5a over the Internet 1.

Upon receipt of such information, the search servers 5a update the viewing result for that contents item using viewer information in the viewer information database 6. Thus, the search servers 5a of this embodiment have the processing functions of the viewing result collection server 7 and the search servers 5 in FIG. 1 in combination.

Additional advantages and modifications will readily occur to those skilled in the art. Therefore, the invention in the broader aspects is not limited to the specific details and representative embodiments shown and described herein. Accordingly, various modifications may be made without departing from the sprit or scope of the general inventive concept as defined by the appended claims and their equivalents.

What is claimed is:

1. A search server comprising:
readout means for searching a search database, which stores guide information and viewing results for contents items each of which is composed of video and audio, in response to a search request in which search conditions including at least a keyword transmitted are specified, from a viewer terminal over a network to thereby read guide information for at least one contents item that satisfies the search conditions; and
transmission means for transmitting to the requesting viewer terminal the read guide information for the at least one contents item and display order priority based on the viewing results for the contents item.

2. The search server according to claim 1, wherein the viewing results include the number of times of viewing and viewer information for each of the contents items.

3. The search server according to claim 1, wherein the guide information includes the title, the genre and the name of a performer of the contents item and the search conditions include a keyword and the option of specifying genre priority or performer priority.

4. The search server according to claim 3, further comprising: transmission means responsive to a request for transmission of information for a contents item specified for transmitting guide information for the contents item and polarity ranking based on the number of times of viewing to the requesting viewer terminal.

5. The search server according to claim 1, further comprising: update means for, each time a contents item stored is transmitted to a viewer terminal, updating the viewing results for the contents item in the search database by collecting information which identifies the contents item and viewer information.

6. A method of search comprising:
searching a search database, which stores guide information and viewing results for contents items each of which is composed of video and audio, in response to a search request in which search conditions including at least a keyword are specified transmitted from a viewer terminal over a network to thereby read guide information for at least one contents item that satisfies the search conditions; and
transmitting to the requesting viewer terminal the read guide information for the at least one contents item and the display order priority based on the viewing results for the contents item.

7. A computer program product of search comprising:
searching a search database, which stores guide information and viewing results for contents items each of which is composed of video and audio, in response to a search request in which search conditions including at least a keyword are specified transmitted from a viewer terminal over a network to thereby read out guide information for at least one contents item that satisfies the search conditions; and
transmitting to the requesting viewer terminal the read guide information for the at least one contents item and display order priority based on the viewing result for the contents item.

8. A contents providing system which, in response to a request for transmission of a contents item from a viewer terminal over a network, reads out the contents item specified by the transmission request from a plurality of stored contents items each of which is made up of video and audio and then transmits the read contents item to the requesting viewer terminal over the network, comprising:
a search database which stores guide information and viewing results for each of the stored contents items; and
a search server which is responsive to a search request in which search conditions including at least a keyword are specified from a viewer terminal over the network to search the search database, then read out guide information for at least one contents item that satisfies the search conditions and transmit to the requesting viewer terminal the read guide information together with display order priority based on the viewing results for each contents item.

9. The contents providing system according to claim 8, wherein the viewing results include the number of times of viewing and viewer information for each of the contents items.

10. The contents providing system according to claim 8, wherein the guide information includes the title, the genre and the name of a performer of each of the contents items and the search conditions include a keyword and the option of specifying genre priority or performer priority.

11. The contents providing system according to claim 8, further comprising: a contents storage server which stores the contents items; and a distribution server which is responsive to a request for transmission of a contents item from a viewer terminal over the network to read out the requested contents item from the contents storage server and send it to the requesting viewer terminal.

12. The contents providing system according to claim 11, wherein the distribution server sends the contents item to the requesting viewer terminal in accordance with a distribution method of either streaming distribution or download distribution specified in the transmission request.

13. The contents providing system according to claim 11, further comprising a viewing result collection server which, each time a contents item is transmitted to a requesting viewer terminal, updates the viewing results for the contents item in the search database by collecting information which identifies the contents item and viewer information.

14. The contents providing system according to claim 11, further comprising a contents information registration unit which writes guide information including the title of a new contents item into the search database.

15. A contents providing method which, in response to a request for transmission of a contents item from a viewer terminal over a network, reads out the contents item specified by the transmission request from a plurality of stored contents items each of which is made up of video and audio and then transmits the read contents item to the requesting viewer terminal over the network, comprising:
each time a contents item is transmitted to a requesting viewer terminal, updating viewing results for the contents item in a search database which stores guide information and viewing results for the stored contents items by collecting information which identifies the contents item and viewer information; and
in response to a search request in which search conditions including at least a keyword are specified from a viewer terminal over the network, searching the search database, then reading guide information for at least one contents item that satisfies the search conditions and transmitting to the requesting viewer terminal the read guide information together with the display order priority based on the viewing results for each contents item.
